(19) United States
(12) Patent Application Publication
(10) Pub. No.: US 2012/0326550 A1
(43) Pub. Date: Dec. 27, 2012

(54) STATOR MANUFACTURING METHOD, STATOR, AND MOTOR

(75) Inventors: Yoshimasa KINPARA, Toyohashi-shi (JP); Yasuhiro KANEMATSU, Toyohashi-shi (JP)

(73) Assignee: ASMO CO., LTD., Kosai-shi (JP)

(21) Appl. No.: 13/530,800

(22) Filed: Jun. 22, 2012

(30) Foreign Application Priority Data
Jun. 27, 2011 (JP) 2011-142251

(51) Int. Cl. H02K 21/14; H02K 15/085; H02K 3/34

(52) U.S. Cl. 310/156.54; 310/215; 29/596

(57) ABSTRACT

A stator manufacturing method includes the steps of preparing an armature core, forming an insulating member including two opposing portions from a sheet-like insulating material, and deforming the insulating member to move the two opposing portions toward each other. The method also includes the step of inserting distal parts of the two opposing portions into the corresponding slit from the axial direction thereby covering an inner surface of each of the slot with the insulating member. Further, the method includes the steps of inserting a conductor forming a winding into each of the slots between the two opposing portions.

### BACKGROUND OF THE INVENTION

The present invention relates to a stator manufacturing method, a stator, and a motor including the stator.

A known stator for a motor includes segment conductor (SC) windings. Such a stator includes an insulating member arranged between a conductor, which forms a winding, and an armature core to ensure insulation between the conductor and the armature core. It is known that a stator including SC windings increases the occupancy rate of windings.

Japanese Laid-Open Patent Publication No. 2000-308314 describes a stator including sheet-like insulating members. An armature core of such a stator includes a plurality of slots arranged along the circumferential direction. A slit is formed inward in the radial direction from each slot. The slit has a smaller width in the circumferential direction than the slot. Each slit opens to the interior of the corresponding slot and the radially inward side of the armature core. The insulating member is tubular and have ends joined with each other in an overlapping state. The insulating member is inserted into the corresponding slot from one axial end of the slot so that the overlapping portion where the ends of the insulating member are joined faces an inner wall surface of the slot that is located at the radially outer side of the slot.

In the stator of Japanese Laid-Open Patent Publication No. 2000-308314, the overlapping portion has a thickness that is two times greater than the thickness of the insulating member in the slot. This reduces the area that can be occupied by a winding and thereby lowers the occupancy rate.

Further, when inserting the insulating member, which is shaped into a tetragonal tube in correspondence with the shape of the slot, as described in Japanese Laid-Open Patent Publication No. 2000-308314, the insulating member may have to be deformed during insertion. In such a case, the overlapping portion and four corners of the insulating member resist deformation. This makes it difficult to deform and narrow the insulating member in the circumferential direction of the slot. Thus, it becomes difficult to insert the insulating member into the slot without rubbing the insulating member against the wall surface of the slot. When the insulating member is rubbed against an open edge of the slot in the axial direction or the wall surface of the slot, the insulating property of the insulating member may be deteriorated. Accordingly, it would be desirable to use a thick insulating member to ensure insulation between the conductor and the armature core. However, the thick insulating member may lower the occupancy rate.

### SUMMARY OF THE INVENTION

It is an object of the present invention to provide a stator manufacturing method, a stator, and a motor that ensure insulation between the conductor and the armature core without lowering in the occupancy rate.

To achieve the above object, a first aspect of the present invention is a method for manufacturing a stator. The method includes the step of preparing an armature core including a plurality of slots arranged along a circumferential direction and a plurality of slits respectively arranged inward in a radial direction from the slots. Each of the slots extends through the armature core in an axial direction, each of the slits is connected to the corresponding one of the slots and opens inward in the radial direction from the armature core, and each of the slits has a width in the circumferential direction that is less than that of the slots. The method further includes forming an insulating member from a sheet-like insulating material. The insulating member includes two opposing portions, which are opposed to each other, and an insulating connection portion, which connects basal ends of the two opposing portions. The method also includes deforming the insulating member to move the two opposing portions toward each other so that a width of the insulating member becomes less than or equal to the width of the slots in the circumferential direction, inserting the insulating member, which is deformed, into each of the slots from the axial direction of the armature core while inserting distal parts of the two opposing portions into the corresponding slit from the axial direction thereby covering an inner surface of each of the slot with the insulating member, and inserting a conductor forming a winding into each of the slots from the axial direction so as to be located between the two opposing portions.

A second aspect of the present invention is a stator including an armature core including an annular portion and a plurality of teeth extending inward in a radial direction from the annular portion. Each of the teeth includes a distal part from which two rotor opposing portions project in a circumferential direction. Each of the rotor opposing portions includes a distal surface. The distal surface has a length in the radial direction that is greater than a projecting length of the rotor opposing portions in a circumferential direction. A slot is formed between the ones of the teeth adjacent to each other in the circumferential direction. A slot formation surface forming the slot includes two side surfaces facing each other in the teeth that are adjacent to each other in the circumferential direction and a connecting surface connecting outer ends of the side surfaces in the radial direction. A slit is formed inward in the radial direction from each of the slots between the distal surfaces of the corresponding rotor opposing portions facing each other in the circumferential direction. The slit is connected to the corresponding slot and opens inward in the radial direction from the armature core. The slit has a width in the circumferential direction that is less than a width of the slot in the circumferential direction. A plurality of insulating members covers the slot formation surface. Each of the insulating members is sheet-shaped and includes two opposing portions and an insulating connection portion. The two opposing portions cover the two side surfaces, respectively. The insulating connection portion connects basal ends located at outer sides of the two opposing portions in the radial direction and covers the connecting surface. The two opposing portions include distal parts located inward in the radial direction and arranged in the slit. A plurality of conductors forms a winding. Each of the conductors is inserted into a corresponding one of the slots between the two opposing portions.

A third aspect of the present invention is a motor including the stator of the second aspect and a consequent pole type rotor arranged in the stator. The rotor includes an annular rotor core and a plurality of magnets fixed to the rotor core. The magnets have the same magnetism. The rotor includes a small magnetic light-weight portion having a specific gravity and magnetism that are less than those of a rotor core material forming the rotor core.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view of a motor according to one embodiment of the present invention;

FIG. 2 is a partially cross-sectional view of a stator and a rotor of FIG. 1;

FIG. 3 is a partially enlarged cross-sectional view of the stator of FIG. 2;

FIG. 4A is a partially enlarged perspective view of an armature core of FIG. 3;

FIG. 4B is a cross-sectional view of the armature core taken along line IV-IV in FIG. 4A;

FIG. 5 is a partially cross-sectional view of the stator of FIG. 2;

FIG. 6 is a schematic view of a segment conductor of FIG. 5;

FIG. 7 is a perspective view of the rotor of FIG. 2;

FIG. 8A is a plan view of an insulating member of FIG. 3;

FIG. 8B is a perspective view of the insulating member of FIG. 8A;

FIG. 9 is a schematic view showing an inserting step of the insulating member of FIG. 8B;

FIG. 10 is a partial cross-sectional view of the armature core and the insulating member showing the inserting step of FIG. 8B;

FIG. 11 is a partial cross-sectional view of the armature core and the insulating member subsequent to the inserting step of the insulating members;

FIGS. 12A to 13B are schematic views showing a widening step;

FIG. 14 is a schematic view showing a deforming step; and

FIG. 15 is a schematic view showing a conductor inserting step.

### DETAILED DESCRIPTION OF THE PREFERRED EMBODIMENTS

One embodiment of the present invention will now be described with reference to the drawings.

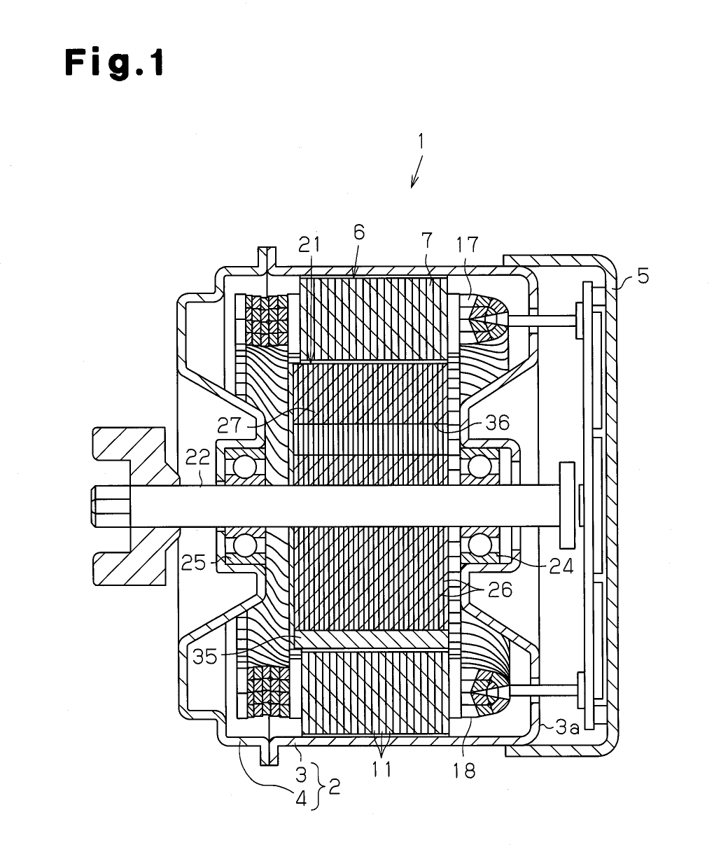

As shown in FIG. 1, a motor 1 includes a motor case 2 formed by a tubular housing 3, which has a closed end, and a front end plate 4, which closes an open front side (left side in FIG. 1) of the tubular housing 3. A circuit accommodating box 5, which accommodates circuit substrates such as a power supply circuit, is attached to rear side (right side in FIG. 1) of the tubular housing 3.

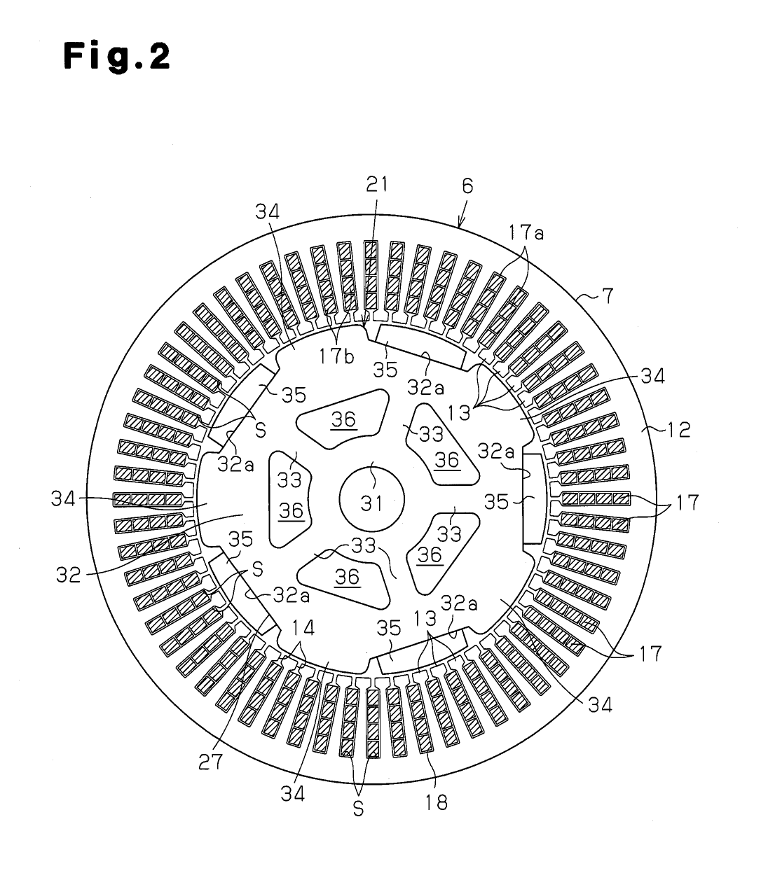

A stator 6 is fixed to an inner circumferential surface of the tubular housing 3. The stator 6 includes an armature core 7. The armature core 7 is formed by stacking a plurality of plate-shaped core sheets 11, which are formed from steel plates. As shown in FIG. 2, the armature core 7 includes an annular portion 12 and a plurality of teeth 13 arranged along a circumferential direction. Each tooth 13 extends inward in a radial direction from the annular portion 12. The armature core 7 of the present embodiment includes sixty teeth 13.

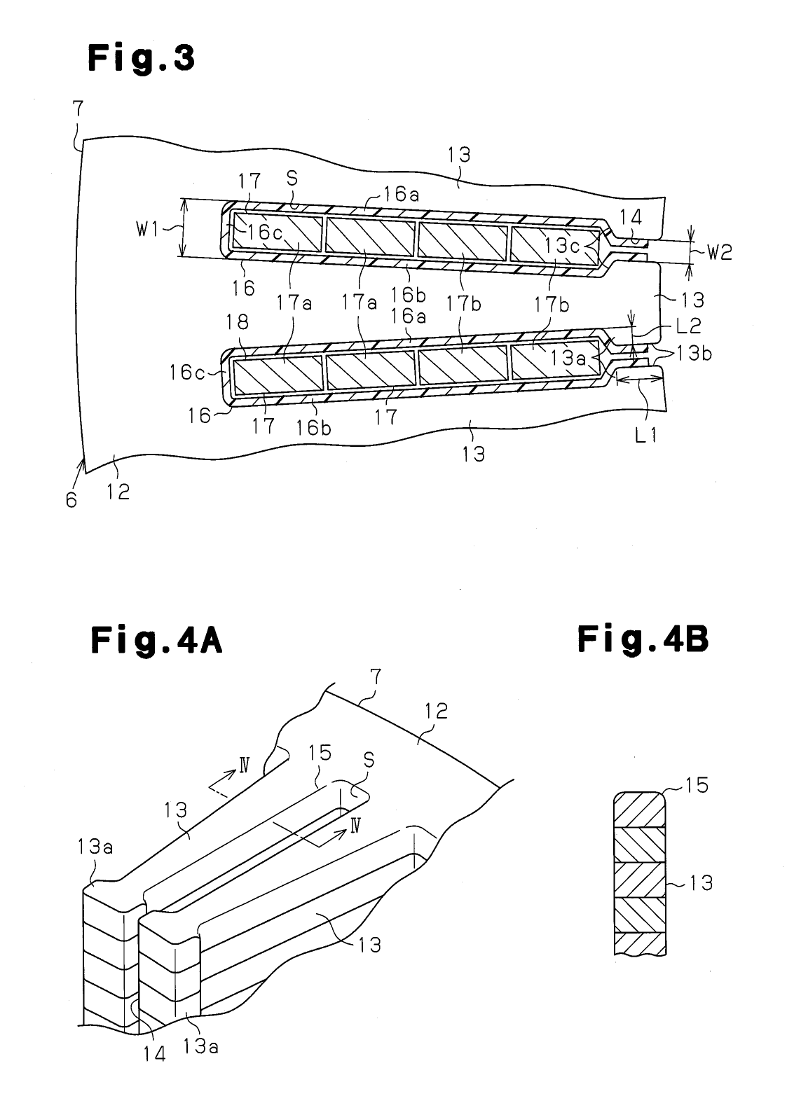

As shown in FIG. 3, each tooth 13 has a distal portion located at the radially inner side of the tooth 13 defining two rotor opposing portions 13a, which project away from each other in the circumferential direction. Each rotor opposing portion 13a includes a distal surface (i.e., end surface in the circumferential direction of the rotor opposing portion 13a) that defines a flat surface 13b substantially extending along the radial direction parallel to an axial direction. The flat surfaces 13b of the rotor opposing portions 13a that face toward each other in the circumferential direction are parallel. The flat surface 13b has a radial length L1 that is greater than a projecting amount L2 of the rotor opposing portion 13a in the circumferential direction. Further, each rotor opposing portion 13a includes an inclined surface 13c located at a radially outer side of the rotor opposing portion 13a. Each inclined surface 13c is inclined away from the annular portion 12 from a basal end towards a distal end of the rotor opposing portion 13a.

In the armature core 7, a slot S extends through the armature core 7 in the axial direction between teeth 13 that are adjacent to each other in the circumferential direction. Inward in the radial direction from the slot S, the rotor opposing portions 13a of the adjacent teeth 13 form a slit 14 in between. The slot S has a width W1 in the circumferential direction, and the slit 14 has a width W2 in the circumferential direction. The width W2 is less than the width W1. Each slit 14 is a gap formed between the flat surfaces 13b facing each other in the circumferential direction. The slit 14 opens at its two opposite side in the radial direction. The slit 14 opens to the interior of the slot S outward in the radial direction and opens to the space in the armature core 7 inward in the radial direction (i.e., space provided inward in the radial direction from the distal surfaces of the teeth 13). Further, each slit 14 also opens at its two opposite sides in the axial direction. Each slot S is in communication with the space in the armature core 7 through the corresponding slit 14. In the present embodiment, each slot S is formed by space between the adjacent teeth 13 and is located outward in the radial direction from the flat surface 13b. In other words, the slot S is formed by a slot formation surface including two opposing side surfaces of adjacent teeth 13 and a connecting surface that connects the radially outer sides of the side surfaces. Specifically, each slot S is a space surrounded by the portion located outward in the radial direction from the rotor opposing portions 13a of the teeth 13 that are adjacent to each other in the circumferential direction, the corresponding inclined surfaces 13c, and the inner surface of the annular portion 12 exposed inward in the radial direction between the adjacent teeth 13.

As shown in FIGS. 4A and 4B, a chamfered portion 15 is formed by chamfering the edges of each slot S at both axial ends of the slot S. The chamfered portion 15 is formed by, for example, pressing the edges of the openings. In the present embodiment, the chamfered portion 15 is curved.

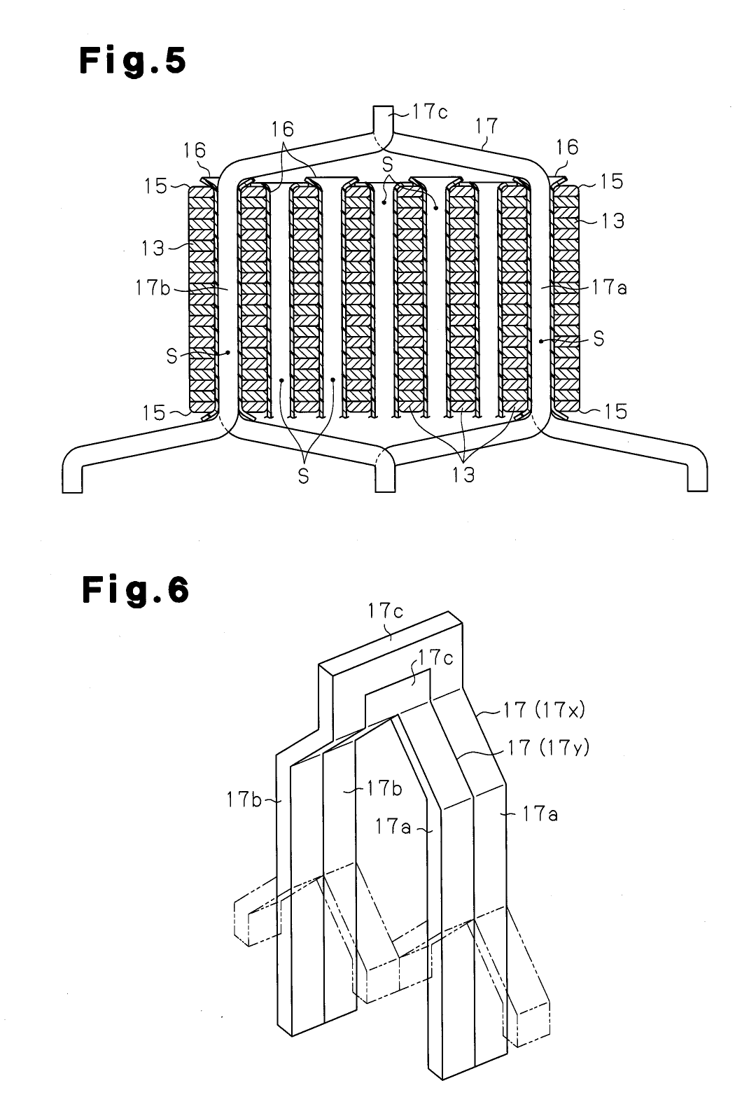

As shown in FIG. 3, a sheet-like insulating member 16, which is formed from an insulating resin material, is inserted into each slot S. The insulating member 16 of the present embodiment has a thickness that is less than one-half of the width W2 of the slit 14 in the circumferential direction. Each insulating member 16 is folded so that its two ends face each other. The insulating member 16 is inserted into the slot S in the axial direction. The insulating member 16 includes two opposing portions 16a and 16b and an insulating connection portion 16c. The opposing portion 16a and 16b cover the two surfaces of the slot S opposing each other in the circumferential direction. The insulating connection portion 16c connects the basal ends at the radially outer side of the two opposing portions 16a and 16b to cover the radially outer side of the slot S. The radially inner ends of the two opposing portions 16a and 16b are arranged in the slit 14. In each insulating member 16, the two opposing portions 16a and 16b are spaced apart in the circumferential direction. The insulating member 16 inserted to the slot S is shaped to lie along and cover the inner surface of the slot S. In other words, the insulating member 16 covers the two opposing side surfaces of the teeth 13 adjacent to each other in the circumferential direction (specifically, the portion located outward in the radial direction from the rotor opposing portions 13a), the inclined surfaces 13c, and the inner surface of the annular portion 12 between the adjacent teeth 13 and exposed inward in the radial direction (side surface of the annular portion 12 connecting the radially outer ends of the two opposing portions 16a and 16b and located outward in the radial direction from the slot S). Further, the radially inner ends of the two opposing portions 16a and 16b in each insulating member 16 cover the flat surfaces 13b of the corresponding slit 14. As shown in FIG. 5, the insulating member 16 is longer than the slot S in the axial direction and projects outward from the two axial ends of the slot S.

As shown in FIG. 2, a segment winding 18 of a three phase (U phase, V phase, W phase) Y-connection is wound around the armature core 7. The segment winding 18 is formed by electrically connecting a plurality of segment conductors 17. Each segment conductor 17, which is formed by a wire having a uniform cross-sectional shape, is substantially U-shapes and includes two linear portions 17a and 17b and a connection portion 17c, which connects the linear portions 17a and 17b. As shown in FIGS. 5 and 6, the linear portions 17a and 17b extend through the slots S at different positions in the circumferential direction and are arranged at different radial positions (inner and outer sides) in the slot S.

Moreover, as shown in FIGS. 4 and FIG. 6, in the stator 6 of the present embodiment, four linear portions 17a and 17b are arranged in the radial direction in each slot S. There are two types of segment conductors 17. In the first type, the two linear portions 17a and 17b are arranged as the first and fourth ones from the radially inner side (segment conductor 17x illustrated on the outer side in FIG. 6). In the second type, the two linear portions 17a and 17b are arranged as the second and third ones from the radially inner side (segment conductor 17y illustrated on the inner side in FIG. 6). The segment winding 18 is mainly formed by the two types of substantially U-shaped segment conductors described above. However, a special type of segment conductor (e.g., segment conductor including only one linear portion) is used as the segment conductor 17 that forms the part of the segment winding 18 that becomes, for example, a winding end (power supply connecting terminal or neutral connecting terminal).

As shown in FIGS. 5 and 6, the distal part of each of the linear portions 17a and 17b extended through the slot S in the axial direction and projected outward is deformed (bent). The deformed distal part is welded and electrically connected to another distal part or a special type of segment conductor. The segment winding 18 is configured by the segment conductors 17 by electrically connecting the distal parts of the linear portions 17a and 17b to the distal parts of other linear portions 17a and 17b or special types of segment conductors. Each of the linear portions 17a and 17b is inserted into an insulating member 16 and extended through the slot S. The distal part of each of the linear portions 17a and 17b is bent near the chamfered portion 15 and forced against the chamfered portion 15 by way of the insulating member 16. In FIG. 6, the bent distal part of each of the linear portions 17a and 17b are shown by broken lines. The segment conductors 17 are electrically insulated from the armature core 7 by the insulating members 16 arranged between the segment conductors 17 and the armature core 7.

As shown in FIG. 1, a rotor 21 is arranged inside the stator 6. A rotation shaft 22 is inserted through the rotor 21. The rotor 21 is fixed to the rotation shaft 22. In the present embodiment, the rotation shaft 22 is made of metal (preferably, non-magnetic) and axially supported by a bearing 24, which supports a bottom portion 3a of the tubular housing 3, and a bearing 25, which supports the front end plate 4.

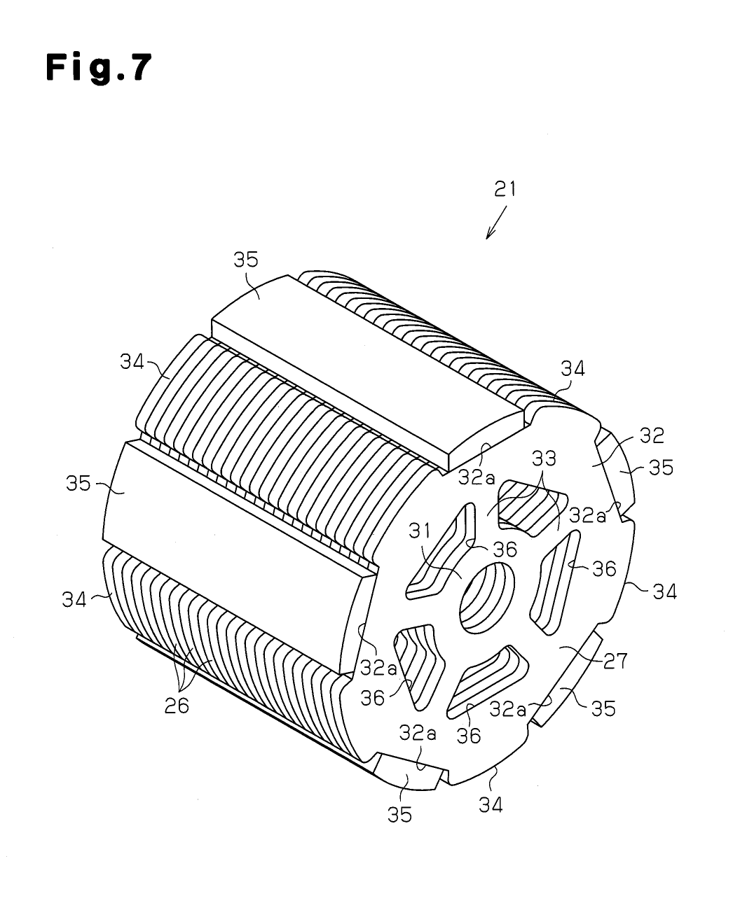

The rotor 21 is a consequent pole type rotor. As shown in FIG. 7, the rotor 21 includes an annular rotor core 27 formed by stacking a plurality of rotor core sheets 26, which are formed from steel plates. The rotor core 27 is fitted and fixed to the rotation shaft 22.

As shown in FIGS. 1, 2 and 7, the rotor core 27 includes a shaft fixing tubular portion 31, which is cylindrical and fitted to the rotation shaft 22, a magnet fixing tubular portion 32, which surrounds the shaft fixing tubular portion 31 and is spaced apart from the shaft fixing tubular portion 31 by a constant distance, and bridging portions 33, which connect the shaft fixing tubular portion 31 and the magnet fixing tubular portion 32 so that the distance between the shaft fixing tubular portion 31 and the magnet fixing tubular portion 32 is constant.

An outer circumferential surface of the magnet fixing tubular portion 32 includes five recesses 32a arranged at equal angular intervals in the circumferential direction. Each recess 32a is fan-shaped as viewed from above, and extends over the entire axial length. Five salient poles 34 are formed in the magnet fixing tubular portion 32 between the recesses 32a.

A magnet 35 is fixed to each of the five recesses 32a, which are arranged in the circumferential direction. Each of the five magnets 35 is arranged so that its radially inner surface relative to the rotor core 27 functions as an N pole and its radially outer surface facing the stator 6 functions as an S pole. As a result, the outer surfaces facing the stator 6 of the salient poles 34 that are adjacent to the magnets 35 in the circumferential direction functions as an N pole, which differs from the magnetic poles at the outer surfaces of the magnet 35.

The number of teeth 13 in the stator 6 represented by “Z” and corresponding to the rotor 21 of the present embodiment is set as described below.

Here, when the number of magnets 35 (magnetic pole pairs) of the rotor 21 is represented by “p” (where p is an integer greater than or equal to two) and the number of phases of the segment winding 18 is represented by “m”, the number “Z” of the teeth 13 can be expressed as,

“Z=2×p×m×n” (where n is a natural number).

In the present embodiment, based on this equation, the number “Z” of the teeth 13 is Z=2×5 (number of magnets 35)×3 (number of phases)×2=60.

The five bridging portions 33 connecting and holding the shaft fixing tubular portion 31 and the magnet fixing tubular portion 32 are arranged in the rotor 21. Each bridging portion 33 extends from the circumferential surface of the shaft fixing tubular portion 31 and is connected to an inner circumferential surface of the magnet fixing tubular portion 32. Specifically, each bridging portion 33 is connected to the inner circumferential surface of the magnet fixing tubular portion 32 at a location corresponding to the recess 32a. Further, each bridging portion 33 is arranged so that its circumferentially central position (angle) is aligned in the radial direction with a circumferentially central position (angle) of the corresponding magnet 35. The five bridging portions 33 divides the space formed between the circumferential surface of the shaft fixing tubular portion 31 and the inner surface of the magnet fixing tubular portion 32 into five in the circumferential direction. Five voids 36 extend in the axial direction between the shaft fixing tubular portion 31 and the magnet fixing tubular portion 32. The voids 36 have a small specific gravity and magnetism compared to a rotor core material formed by stacking steel plates. The formation of the voids 36 decreases the weight of the rotor core 27 and, consequently, the motor 1. In other words, the void 36 serves as a small magnetic light-weight portion.

As shown in FIGS. 1 and 2, in the motor 1 described above, a rotational magnetic field for rotating the rotor 21 is generated in the stator 6 when drive current is supplied from the power supply circuit in the circuit accommodating box 5 to the segment winding 18. This transfers magnetic flux between the teeth 13 and rotates the rotor 21.

A manufacturing method of the stator 6 of the present embodiment will now be described.

First, as shown in FIGS. 4A and 4B, a chamfering step is performed to chamfer the edges of the two open axial ends of each slot S. In the chamfering step, the edges of the opening at the two axial ends of each slot S are chamfered to curve the edge. This forms the curved chamfered portion 15 at the open edge of each slot S.

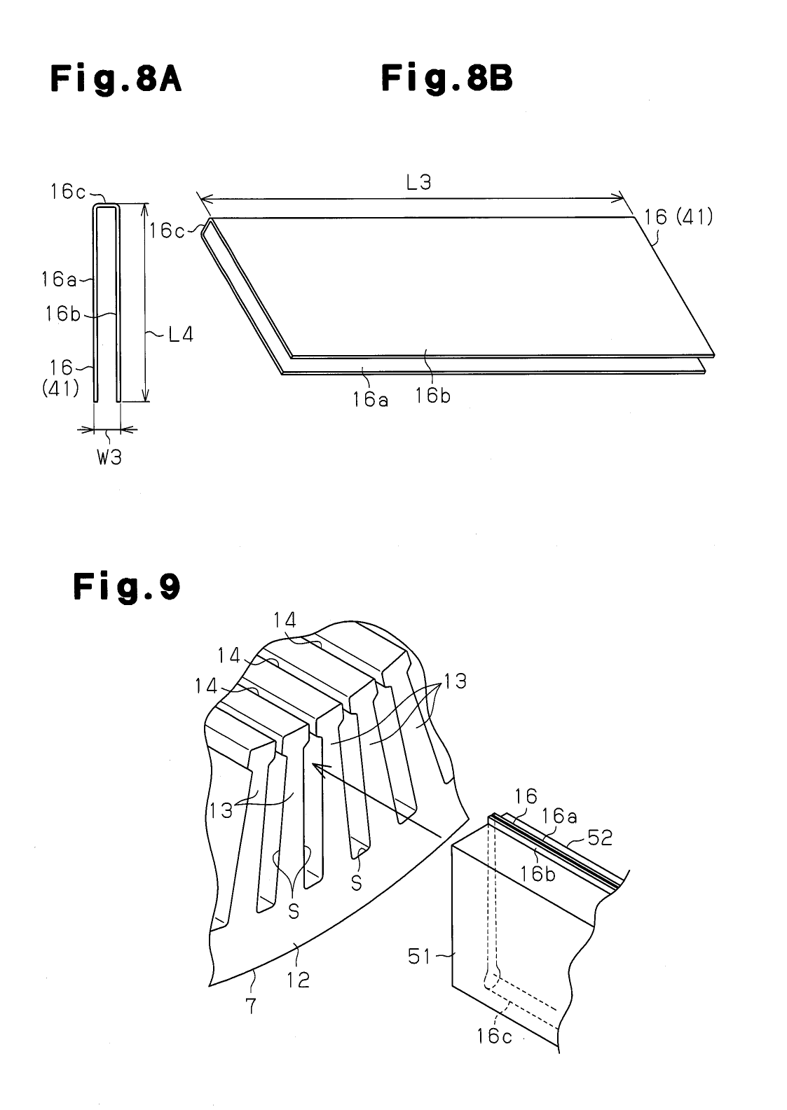

As shown in FIGS. 8A and 8B, an insulating member forming step of forming the insulating member 16 having a substantially C-shaped cross-section from a sheet-like insulating material 41 is carried out. The insulating material 41 has the form of a tetragonal sheet. In the insulating member forming step, the insulating material 41 is folded so that its two ends face each other. The insulating member 16, which is formed from the insulating material 41, has a C-shaped cross-section including the two opposing portions 16a and 16b, which face each other, and the insulating connection portion 16c, which connects the basal ends of the two opposing portions 16a and 16b.

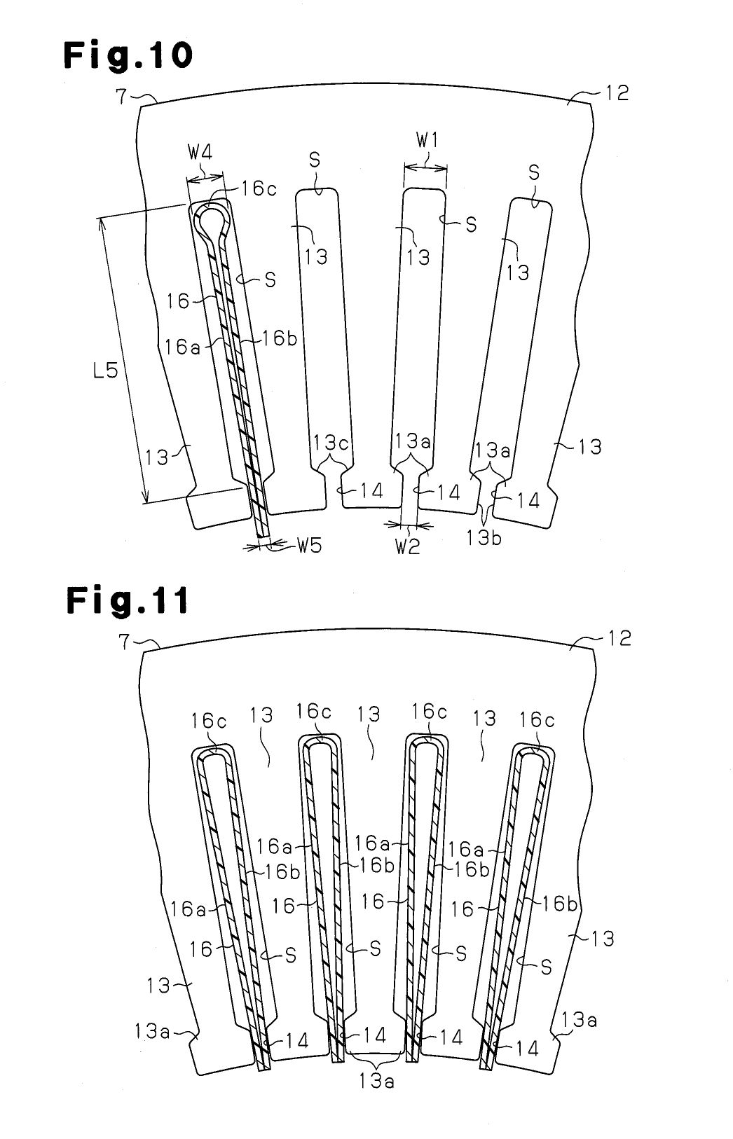

In the insulating member 16 formed in the insulating member forming step, the opposing portions 16a and 16b face each other in the thickness direction and extend in parallel. The insulating connection portion 16c is tetragonal, and the opposing portions 16a and 16b are perpendicular to the insulating connection portion 16c. A width W3 of the insulating member 16 (width in the opposing direction of the opposing portions 16a and 16b) is slightly less than the width W1 of the slot S in the circumferential direction (see FIG. 3). Further, a length L3 of the insulating member 16 (length in a direction parallel to the opposing portions 16a and 16b and the insulating connection portion 16c) is longer than the axial length of the slot S. A length L4 of the opposing portions 16a and 16b in a direction orthogonal to the insulating connection portion 16c is greater than a radial length L5 of the slot S shown in FIG. 10 and is substantially equal to a radial length of the teeth 13 (i.e., length between the basal end and the distal part of a tooth 13) in the present embodiment.

Then, as shown in FIG. 9, an insulating member inserting step of inserting the insulating member 16 into the slot S is carried out. In the insulating member inserting step, the opposing portions 16a and 16b of the insulating member 16 formed in the insulating member forming step are lightly held from two sides in the opposing direction of the opposing portions 16a and 16b by two jigs 51 and 52, which are driven by a driving device (not shown). This moves the opposing portions 16a and 16b toward each other and simultaneously deforms the insulating connection portion 16c to narrow the space between the opposing portions 16a and 16b. The insulating member 16 sandwiched by the jigs 51 and 52 is deformed (bent) from the shape formed in the insulating member forming step, and a width W4 becomes less than the width W1 in the circumferential direction of the slot S, as shown in FIG. 10. Further, a width W5 of the insulating member 16 is less than the width W2 in the circumferential direction of the slit 14 at the distal parts of the opposing portions 16a and 16b at the opposite side of the insulating connection portion 16c.

As shown in FIG. 9, the insulating member 16 held between the jigs 51 and 52 is then arranged to axially face the open axial end of one of the slots S so that the end at the insulating connection portion 16c faces the radially outer side of the armature core 7 and the end opposite to the insulating connection portion 16c faces the radially inner side of the armature core 7. In this case, the insulating connection portion 16c is extended along the axial direction of the armature core 7. The insulating member 16 is then moved relative to the jigs 51 and 52 along the axial direction of the armature core 7 by a tool (not shown) and inserted into the slot S along the axial direction of the armature core 7 from the open axial end of the slot S. In this case, the ends of the two opposing portions 16a and 16b opposite to the insulating connection portion 16c (i.e., radially inner ends of the opposing portions 16a and 16b) are inserted into the slit 14 from the axial direction. As shown in FIG. 10, the ends of the two opposing portions 16a and 16b opposite to the insulating connection portion 16c may project outward to the inner side of the armature core 7 from the slit 14. Further, the insulating member 16 is held between the jigs 51 and 52. Thus, the width W4 is less than the width W1 in the circumferential direction of the slot S, and the width W5 at the end of the insulating member 16 opposite to the insulating connection portion 16c is less than the width W2 in the circumferential direction of the slit 14, as described above. Thus, the insulating member 16 can be inserted into the slot S without contacting the inner surfaces of the slot S and the inner surfaces (i.e., flat surfaces 13b) of the slit 14.

The insulating member 16 is extended through the slot S in the axial direction until its two sides both project outward in the axial direction from the slot S. Then, the insulating member 16 inserted into each slot S is released from the clamping force applied by the jigs 51 and 52 so that the elastic force of the insulating member 16 moves the opposing portions 16a and 16b away from each other in the circumferential direction, as shown in FIG. 11. Then, the end of the opposing portions 16a and 16b opposite to the insulating connection portion 16c, that is, the radially inner ends of the opposing portions 16a and 16b come into contact with the surfaces of the slit 14. Thus, the insulating member 16 is easily held in the slot S by frictional force between the radially inner ends of the opposing portions 16a and 16b and the surfaces of the slit 14.

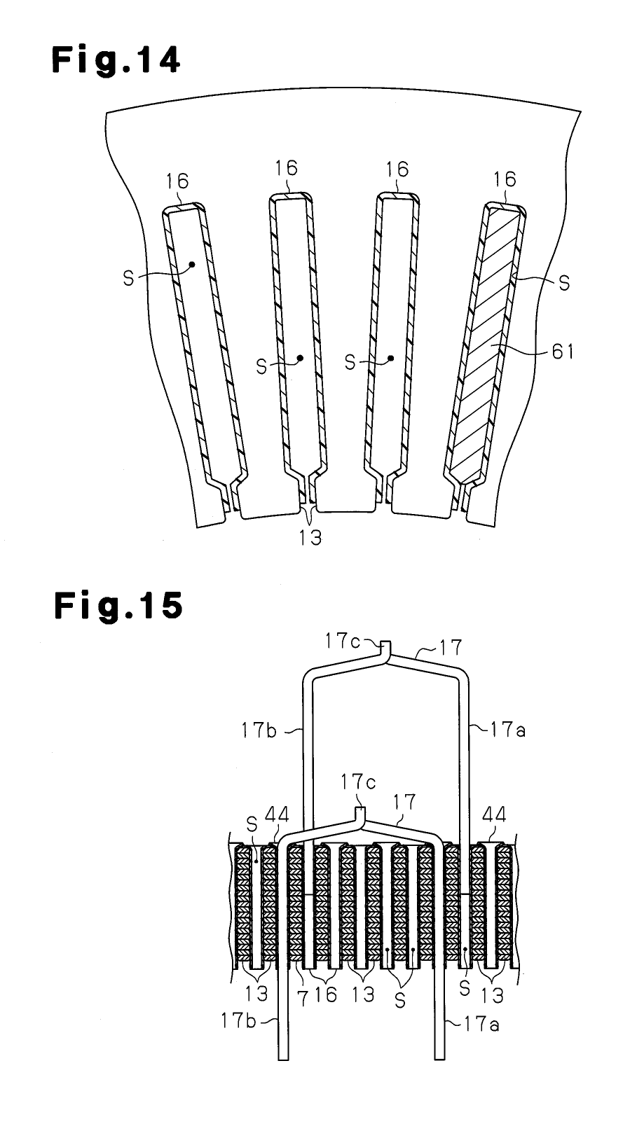

An insulating member deforming step of deforming the insulating member 16 to extend along the inner surface of the slot S is then carried out. As shown in FIG. 14, the insulating member deforming step uses a rod-shaped heating tool 61, which has a cross-sectional shape that is slightly smaller by an amount corresponding to the thickness of the insulating member 16 than the cross-sectional shape of the slot S in a direction perpendicular to the axial direction. The heating tool 61 can be moved along the axial direction of the armature core 7 by a driving device (not shown). Each insulating member 16 is deformed to lie along the inner surface of the slot S by inserting the heating tool 61, which is heated to a predetermined temperature, into the insulating member 16. In this case, the heating tool 61 is inserted into the slot S from one open axial end of the slot S to a depth that is about one third of the slot S. This deforms the insulating member 16 to a shape that conforms to the inner surfaces of the slot S at one axial side of the slot S and thus expands the space in the insulating member 16 in the circumferential direction.

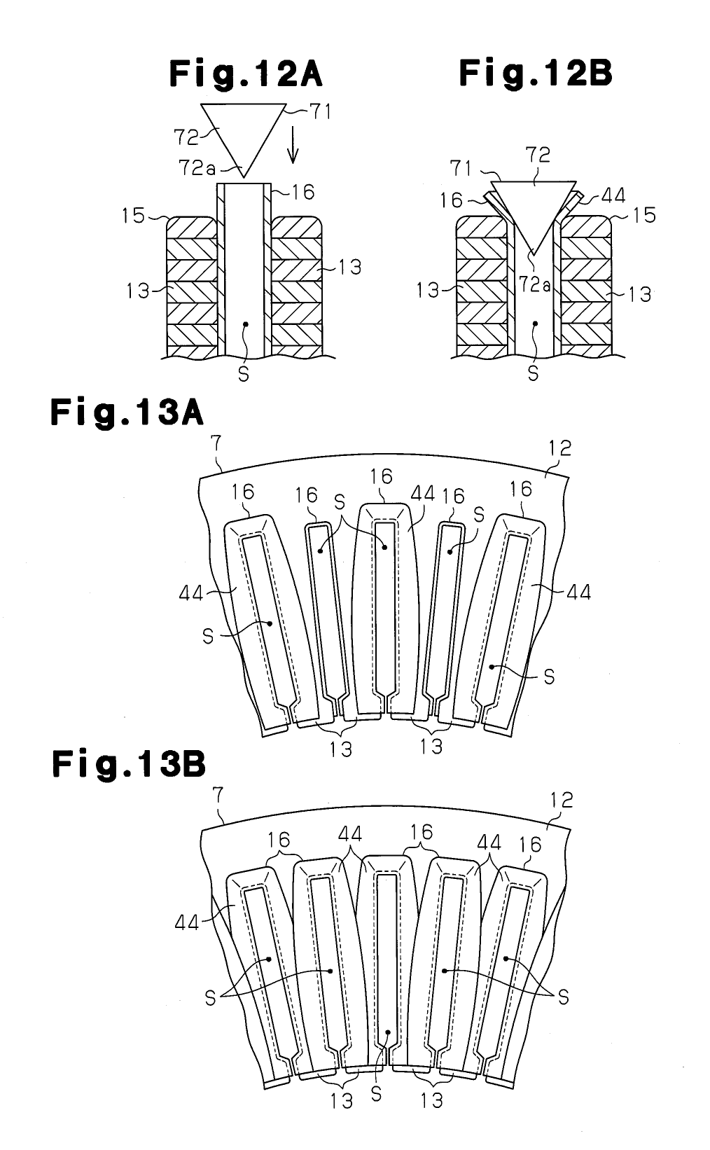

As shown in FIGS. 12A and 12B, a widening step of widening, in the circumferential direction, one axial end of the insulating member 16 projecting out in the axial direction from the slot S is carried out. In the widening step, a heat shaping tool 71 heated to a predetermined temperature is pressed against one axial end of the insulating member 16 projecting out of an open axial end of the slot S. The heat shaping tool 71 includes a plurality of heat shaping units 72 having pyramidal shapes and formed integrally with each other. Only one of the heat shaping units 72 is shown in FIGS. 12A and 12B. A distal end 72a of the heat shaping unit 72 is shaped in correspondence with the slot S and can be inserted into the slot S. A basal portion of the heat shaping unit 72 has a width in the circumferential direction that is greater than the width of the slot S in the circumferential direction. Further, a plurality of (thirty in the present embodiment) heat shaping units 72 are arranged at predetermined intervals in the circumferential direction so that they can be simultaneously inserted into every second slot S.

As shown in FIG. 12A, the heat shaping units 72, which are heated to a predetermined temperature, are moved by a driving device (not shown) of the heat shaping tool 71 in the axial direction to contact to the inner side of the axial ends of the insulating members 16 projecting from the open axial ends of the slots S. The axial end of each insulating member 16 projecting from the open axial end of the slot S is the end at the side into which the heating tool 61 was inserted in the deforming step. As shown in FIG. 12B, each heat shaping unit 72 is then pressed against the inner side of the corresponding insulating member 16 until the distal end 72a is inserted into the slot S from the open axial end of the slot S. The axial end of the insulating member 16 projecting outward from the open axial end of the slot S is widened in the circumferential direction in accordance with the outer shape of the heat shaping unit 72. In other words, a widened portion 44 widened in the circumferential direction is formed at one axial end of the insulating member 16 that projects outward from the open axial end of the slot S.

In the widening step of the present embodiment, as shown in FIG. 13A, when the widened portion 44 is formed at one axial end of the insulating member 16 inserted into every second slot S in the circumferential direction, the heat shaping unit 72 is separated from the armature core 7 in the axial direction by the driving device. Then, the heat shaping unit 72 is moved in the circumferential direction by an amount corresponding to one slot by the driving device, and the widened portions 44 are formed in the same manner at axial ends of the insulating members 16 inserted into the remaining slots S by the heat shaping unit 72, as shown in FIG. 13B.

Then, as shown in FIG. 15, a conductor inserting step of inserting a plurality of segment conductors 17 from the axial direction into the insulating member 16 in the slots S is carried out. In the conductor inserting step, two linear portions 17a and 17b of each segment conductor 17 are inserted into two slots S spaced apart by a predetermined number of slots S in the circumferential direction. The linear portions 17a and 17b are inserted from the widened portion 44 into the insulating members 16. The segment conductor 17 is moved relative to the armature core 7 along the axial direction of the armature core 7 until the distal parts of the linear portions 17a and 17b project out of the corresponding slots S from the other open axial end (i.e., opening opposite to the widened portions 44).

Next, a bending step of bending, in the circumferential direction, the distal parts of the linear portions 17a and 17b projecting out of the other opening axial ends of the slots S is carried out. As shown in FIG. 5, in the bending step, the linear portions 17a and 17b are pushed against the chamfered portion 15 and bent in the circumferential direction near the chamfered portion 15, which is arranged at the edge of the other open axial end of the slot S. The bending of the distal part of each of the linear portions 17a and 17b in the circumferential direction arranges the distal part of the linear portions 17a and 17b adjacent to other linear portions 17a and 17b for connection.

A connecting step of electrically connecting the linear portions 17a and 17b is then carried out. In the connecting step, the linear portions 17a and 17b are welded and electrically connected to different linear portion 17a and 17b. This forms the segment winding 18 from the plurality of conductors 17 and completes the stator 6.

The advantages of the method for manufacturing the stator 6 of the present embodiment will now be described.

The insulating member 16 formed in the insulating member forming step has a substantially C-shaped cross-section. Thus, the ends of the two opposing portions 16a and 16b opposite to the insulating connection portion 16c, that is, the ends at the opening of the C-shaped insulating member 16 can easily be arranged proximal to each other. Accordingly, in the insulating member inserting step, the width in the thickness direction of the opposing portions 16a and 16b can easily be decreased while decreasing the width of the insulating member 16 at the side opposite to the insulating connection portion 16c. This easily allows the insulating member 16 to be deformed (bent) so as to become narrower than the width of the slot S in the circumferential direction.

As described above, the present embodiment has the advantages described below.

(1) The insulating member 16 formed in the insulating member forming step has a substantially C-shaped cross-section. Thus, the ends (distal parts) of the two opposing portions 16a and 16b opposite to the insulating connection portion 16c, that is, the ends at the C-shaped opening side are easily be moved toward or away from each other. Accordingly, the width of the insulating member 16 in the thickness direction at the opposing portions 16a and 16b can easily be decreased while decreasing the width at the end of the insulating member 16 opposite to the insulating connection portion 16c can easily be decreased. Thus, the insulating member 16 can easily be deformed (bent) so as to become narrower than the width W1 in the circumferential direction of the slot S. Thus, when inserting the insulating member 16 into the slot S in the insulating member inserting step, contact of the insulating member 16 with the inner surface of the slot S is suppressed. As a result, damages to the insulating member 16 are suppressed. This ensures insulation between the segment conductor 17 and the armature core 7 even when the insulating member 16 is formed from the insulating material 41 that is thin. Further, the insulating member 16 does not lower the occupancy rate since a portion where the insulating member 16 is overlapped is not formed in the slot S. Accordingly, the lowering in the occupancy rate is suppressed while ensuring insulation between the segment conductor 17 and the armature core 7.

(2) In the conductor inserting step, the segment conductor 17 is easily inserted into the insulating member 16 by inserting the segment conductor 17 from the widened portion 44. The insulating member 16 is thus suppressed from being damaged by the distal ends of the linear portions 17a and 17b. This allows for reduction in the thickness of the insulating member 16.

(3) In the chamfering step, the chamfering processing is performed on the edges of the two open axial ends of the slot S so that damage to the insulating member 16 by the edges of the two axial openings of the slot S is suppressed even when the insulating member 16 is rubbed against the edges in the subsequent insulating member inserting step. This allows for reduction in the thickness of the insulating member 16.

(4) When the insulating member 16 is deformed along the inner surface of the slot S in the deforming step, the space in the insulating member 16 is expanded in the circumferential direction. This further facilitates insertion of the segment conductor 17 into the inner side of the insulating member 16 and further suppresses damage to the insulating member 16 by the distal end of the segment conductor 17. This also allows for reduction in the thickness of the insulating member 16.

(5) After the insulating member 16 is inserted into the slot S in the insulating member inserting step, the radially inner ends of the two opposing portions 16a and 16b (i.e., ends opposite to the insulating connection portion 16c of the two opposing portions 16a and 16b) are inserted into the slit 14. The insulating member 16 entirely covers the inner surface of the slot S if the radially inner ends of the two opposing portions 16a and 16b are arranged in the slit 14 when the insulating member 16 is deformed along the inner surface of the slot S in the deforming step. Accordingly, when the radial length L1 of the distal surface (i.e., flat surface 13b) of the rotor opposing portion 13a is longer than the projecting amount L2 in the circumferential direction of the rotor opposing portion 13a as in the present embodiment, the range in which the radially inner ends of the two opposing portions 16a and 16b may be arranged after the deforming step becomes wider in the radial direction. Thus, the dimensional accuracy of the length (i.e., length L4) between the end on the insulating connection portion 16c and the ends opposite to the insulating connection portion 16c of the two opposing portions 16a and 16b in the insulating member 16 can be lowered. This reduces the manufacturing cost of the stator 6.

(6) Since the winding (segment winding 18) is formed by the segment conductors 17, the occupancy rate can be increased. As a result, the size of the motor 1 per output can be reduced. Further, the edges of the two open axial ends of the slot S are chamfered to form the chamfered portion 15. Thus, damage to the insulating member 16, which is held between the linear portions 17a and 17b and the edges of the slot S, is suppressed when bending the linear portions 17a and 17b of the segment conductor 17 in the circumferential direction.

(7) In the stator 6, the sheet-like insulating member 16 allows the ends of the two opposing portions 16a and 16b opposite to the insulating connection portion 16c, that is, the radially inner ends of the two opposing portions 16a and 16b, to easily move toward and away from each other. Accordingly, the width of the insulating member 16 is easily narrowed in the thickness direction of the opposing portions 16a and 16b while narrowing the width between the ends of the insulating member 16 opposite to the insulating connection portion 16c. Thus, the insulating member 16 is easily deformed (bent) so as to become narrower than the width in the circumferential direction of the slot S. This suppresses contact of the insulating member 16 with the inner surface of the slot S when inserting the insulating member 16 into the slot S. As a result, damage to the insulating member 16 is suppressed, and insulation between the segment conductor 17 and the armature core 7 is ensured even when the insulating member 16 is thin. Further, the lowering in the occupancy rate by the insulating member 16 is suppressed since a portion where the insulating member 16 is overlapped is not formed in the slot S. Accordingly, the lowering in the occupancy rate is suppressed while ensuring insulation between the segment conductor 17 and the armature core 7.

In the stator 6, the insulating member 16 entirely covers the inner surface of the slot S when the radially inner ends of the two opposing portions 16a and 16b are arranged in the slit 14. Accordingly, when the radial length L1 of the distal surface (i.e., flat surface 13b) of the rotor opposing portion 13a is longer than the projecting amount L2 in the circumferential direction of the rotor opposing portion 13a as in the present embodiment, the range in which the ends on the radially inner side of the two opposing portions 16a and 16b may be arranged in each insulating member 16 becomes wider in the radial direction. Thus, the dimensional accuracy of the radial length of the two opposing portions 16a and 16b can be lowered. This reduces the manufacturing cost of the stator 6.

(8) The motor 1 includes the consequent pole type rotor 21. This reduces the number of magnets 35 coupled to the rotor 21 to one half Accordingly, the manufacturing cost of the motor 1 is reduced. Further, the rotor 21 includes the voids 36. This decreases the weight of the rotor 21 and the entire motor 1 becomes lighter.

(9) When the clamping force of the jigs 51 and 52 that deform the insulating member 16 in the insulating member inserting step is eliminated, the insulating member 16 is elastically returned to its original form, and the two opposing portions 16a and 16b move away from each other in the circumferential direction. Thus, the two opposing portions 16a and 16b of each insulating member 16 are spaced apart in the circumferential direction and contact the inner surfaces (i.e., flat surfaces 13b) of the corresponding slit 14, which is narrower in the circumferential direction than the width W1 of the slot S in the circumferential direction. When the two opposing portions 16a and 16b inserted in the slit 14 contact the inner surfaces of the slit 14, the insulating member 16 resists movement relative to the armature core 7. This easily maintains the insulating member 16 in a state arranged inside the slot S. Accordingly, the step carried out after the insulating member inserting step is easily carried out.

(10) When inserting a tubular insulating member into the slot as in the prior art, the tubular insulating member is required to have high dimensional accuracy. In contrast, the insulating member 16 of the present embodiment has the ends of the two opposing portions 16a and 16b opposite to the insulating connection portion 16c inserted into the slit 14 that opens to the interior of the slot S and the radially inner side of the armature core 7. This allows for the dimensional accuracy of the radial length of the insulating member 16 to be lowered, and the dimensional tolerance can be increased. As a result, the manufacturing cost of the stator 6 can be further reduced.

(11) In the insulating member inserting step, the insulating member 16 has the ends (distal parts) of the two opposing portions 16a and 16b opposite to the insulating connection portion 16c inserted into the slit 14. The slit 14 opens to the interior of the slot S and the radially inner side. In other words, the slit 14 is connected to the corresponding slot S and opens to the radially inner side of the armature core 7. Accordingly, even if the length in the radial direction (radial direction of the armature core 7) of the insulating member 16 increases when the insulating member 16 is bent, the insulating member 16 can easily be inserted into the slot S.

It should be apparent to those skilled in the art that the present invention may be embodied in many other specific forms without departing from the spirit or scope of the invention. Particularly, it should be understood that the present invention may be embodied in the following forms.

In the embodiment described above, the rotor 21 includes the voids 36 but does not have to include the voids 36. The rotor 21 is not limited to the consequent pole type rotor. For instance, the rotor 21 may be a rotor in which an N-pole magnet and an S-pole magnet are alternately arranged in the circumferential direction. Further, the rotor 21 may be a magnet embedded type rotor in which a magnet is embedded in the rotor core for every magnetic pole. The number of magnets 35 of the rotor 21 is not limited to five and may be changed as required.

In the embodiment described above, the conductor inserted to the slot S is the substantially U-shaped segment conductor 17 that forms the segment winding 18. However, the conductor inserted to the slot S is not limited to the segment conductor 17 and may be a conductor made from a copper wire or the like.

In the embodiment described above, the radial length L1 of the distal surface (i.e., flat surface 13b) of the rotor opposing portion 13a is longer than the projecting amount L2 in the circumferential direction of the rotor opposing portion 13a. However, the radial length L1 of the distal surface of the rotor opposing portion 13a may be less than or equal to the projecting amount L2 in the circumferential direction of the rotor opposing portion 13a.

In the embodiment described above, the deforming step is carried out after the insulating member inserting step. Then, the widening step is carried out. However, the two opposing portions 16a and 16b of the insulating member 16 are spaced apart in the circumferential direction after the insulating member inserting step. This allows for insertion of the segment conductor 17. Thus, the deforming step and the widening step do not necessarily have to be carried out. Alternatively, just one of the deforming step and the widening step may be carried as required.

In the embodiment described above, the widening step is carried out after the deforming step but may be carried out before the deforming step as long as the insulating member inserting step has been carried out. The widening step does not necessarily have to be carried out.

In the chamfering step of the embodiment described above, the chamfered portion 15 is formed at each edge of the two axial open ends of the slot S. However, the chamfered portion 15 may be formed at the edge of just one of the two axial opens ends of the slot S.

In the embodiment described above, the chamfering step is carried out before the insulating member forming step. However, the chamfering step may be carried out any time as long as it is before the insulating member inserting step. The chamfering step does not necessarily have to be carried out.

In the deforming step of the embodiment described above, the heating tool 61 is inserted to the depth of about one third of the slot S from the one open axial end of the slot S. However, in the deforming step, the amount of the heating tool 61 inserted into the slot S is not limited. For instance, the heating tool 61 may be inserted through the slot S extending out of the slot S.

In the insulating member inserting step of the embodiment described above, the insulating member 16 is bent so as to become narrower than the width W1 in the circumferential direction of the slot S. However, in the insulating member inserting step, the insulating member 16 may be bent to have the same width as the width W1 in the circumferential direction of the slot S.

The shape of the insulating member 16 formed in the insulating member forming step is not limited to the shape of the embodiment described above as long as it has a substantially C-shaped cross-section. Here, the phrase “substantially C-shaped cross-section” refers to a cross-sectional shape of the insulating member including two opposing portions facing each other and an insulating connection portion connecting the ends of the two opposing portions that face each other. This includes, for example, a U-shaped cross-section. Accordingly, for example, the insulating member 16 may be formed such that the spacing between the opposing portions 16a and 16b becomes wider as the insulating connection portion 16c becomes farther.

In the embodiment described above, the armature core 7 includes sixty slots S in the circumferential direction by including sixty teeth 13. However, the number of teeth 13 (number of slots S) may be changed as required.

The present examples and embodiments are to be considered as illustrative and not restrictive, and the invention is not to be limited to the details given herein, but may be modified within the scope and equivalence of the appended claims.

What is claimed is:

1. A method for manufacturing a stator, the method comprising the steps of:
preparing an armature core including a plurality of slots arranged along a circumferential direction and a plurality of slits respectively arranged inward in a radial direction from the slots, wherein each of the slots extends through the armature core in an axial direction, each of the slits is connected to the corresponding one of the slots and opens inward in the radial direction from the armature core, and each of the slits has a width in the circumferential direction that is less than that of the slots;
forming an insulating member from a sheet-like insulating material, wherein the insulating member includes two opposing portions, which are opposed to each other, and an insulating connection portion, which connects basal ends of the two opposing portions;
deforming the insulating member to move the two opposing portions toward each other so that a width of the insulating member becomes less than or equal to the width of the slots in the circumferential direction;
inserting the insulating member, which is deformed, into each of the slots from the axial direction of the armature core while inserting distal parts of the two opposing portions into the corresponding slit from the axial direction thereby covering an inner surface of each of the slot with the insulating member; and
inserting a conductor forming a winding into each of the slots from the axial direction so as to be located between the two opposing portions.

2. The method according to claim 1, further comprising the step of forming a widened portion by widening, in the circumferential direction of the armature core, a portion of the insulating member projecting out of each of the slits in the axial direction of the armature core after the step of inserting the insulating member, wherein the conductor is inserted into between the two opposing portions from the widened portion.

3. The method according to claim 1, further comprising the step of chamfering an open edge of the slot in the axial direction of the armature core before the step of inserting the insulating member.

4. The method according to claim 1, further comprising the step of deforming the insulating member, which is inserted into each of the slots, along the inner surface of the slot before the step of inserting the conductor.

5. The method according to claim 1, wherein
the armature core includes an annular portion and a plurality of teeth projecting inward in the radial direction from the annular portion,
each of the teeth includes a distal part from which two rotor opposing portions project in the circumferential direction,
each of the rotor opposing portions includes a distal surface,
adjacent ones of the teeth defining in between one of the slots,
the distal surfaces of the rotor opposing portions opposing each other in the circumferential direction defining in between one of the slits, and
a length of the distal surface in the radial direction is greater than a projecting amount of each of the rotor opposing portions in the circumferential direction.

6. The method according to claim 1, wherein
the conductor is a substantially U-shaped segment conductor including two linear portions and a connection portion connecting the linear portions, and
in the step of inserting the conductor, the two linear portions of the segment conductor are inserted to different ones of the slots that are separated in the circumferential direction.

7. A stator comprising:
an armature core including an annular portion and a plurality of teeth extending inward in a radial direction from the annular portion, wherein
each of the teeth includes a distal part from which two rotor opposing portions project in a circumferential direction,
each of the rotor opposing portions includes a distal surface,
the distal surface has a length in the radial direction that is greater than a projecting length of the rotor opposing portions in a circumferential direction,
a slot is formed between the ones of the teeth adjacent to each other in the circumferential direction,
a slot formation surface forms the slot and includes two side surfaces facing each other in the teeth that are adjacent to each other in the circumferential direction and a connecting surface connecting outer ends of the side surfaces in the radial direction,
a slit is formed inward in the radial direction from each of the slots between the distal surfaces of the corresponding rotor opposing portions facing each other in the circumferential direction,
the slit is connected to the corresponding slot and opens inward in the radial direction from the armature core, and
the slit has a width in the circumferential direction that is less than a width of the slot in the circumferential direction;
a plurality of insulating members, each covering the slot formation surface, wherein
each of the insulating members is sheet-shaped and includes two opposing portions and an insulating connection portion,
the two opposing portions cover the two side surfaces, respectively,
the insulating connection portion connects basal ends located at outer sides of the two opposing portions in the radial direction and covers the connecting surface, and
the two opposing portions includes distal parts located inward in the radial direction and arranged in the slit; and
a plurality of conductors forming a winding, wherein each of the conductors is inserted into a corresponding one of the slots between the two opposing portions.

8. A motor comprising:
the stator according to claims 7; and
a consequent pole type rotor arranged in the stator, wherein
the rotor includes an annular rotor core and a plurality of magnets fixed to the rotor core,
the magnets have the same magnetism, and
the rotor includes a small magnetic light-weight portion having a specific gravity and magnetism that are less than those of a rotor core material forming the rotor core.
